(19) United States
(12) Patent Application Publication
(10) Pub. No.: US 2023/0327198 A1
(43) Pub. Date: Oct. 12, 2023

(54) RECHARGEABLE LITHIUM BATTERY

(71) Applicant: SAMSUNG SDI CO., LTD., Yongin-si (KR)

(72) Inventors: Hyunbong CHOI, Yongin-si (KR); Yeji YANG, Yongin-si (KR); Sangwoo PARK, Yongin-si (KR); Sundae KIM, Yongin-si (KR); Sanghoon KIM, Yongin-si (KR); Hongryeol PARK, Yongin-si (KR); Dahyun KIM, Yongin-si (KR)

(21) Appl. No.: 17/988,646

(22) Filed: Nov. 16, 2022

(30) Foreign Application Priority Data
Apr. 12, 2022 (KR) 10-2022-0045330

(51) Int. Cl. H01M 10/0567; H01M 10/0569; H01M 10/0525; H01M 4/525; H01M 4/38; H01M 4/587; H01M 4/36

(52) U.S. Cl. CPC H01M 10/0567; H01M 10/0569; H01M 10/0525; H01M 4/525; H01M 4/386; H01M 4/587; H01M 4/366; H01M 2300/004; H01M 2300/0037

(57) ABSTRACT

A rechargeable lithium battery including an electrolyte solution including a non-aqueous organic solvent, a lithium salt, and an additive; a positive electrode including a positive active material; and a negative electrode including a negative active material is provided. The additive includes a compound represented by Chemical Formula 1, and the positive active material includes a cobalt-free lithium nickel manganese-based oxide.

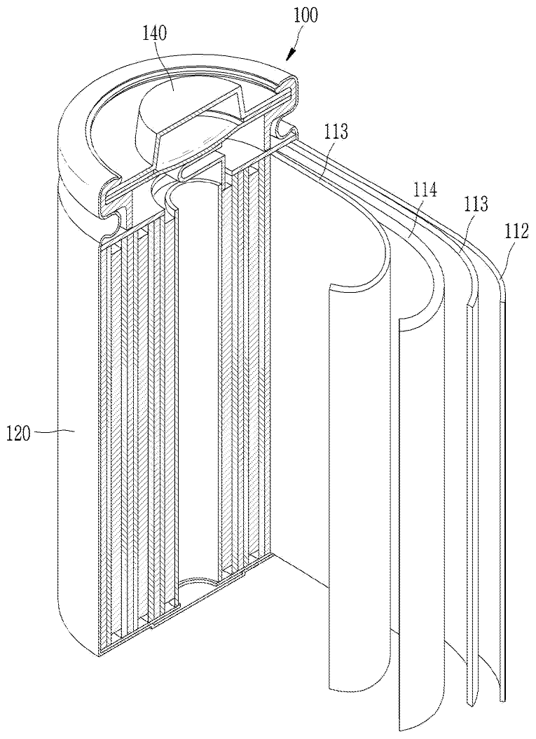

### CROSS-REFERENCE TO RELATED APPLICATION

This application claims priority to and the benefit of Korean Patent Application No. 10-2022-0045330, filed in the Korean Intellectual Property Office on Apr. 12, 2022, the entire content of which is hereby incorporated by reference.

### BACKGROUND

### 1. Field

Aspects of one or more embodiments of the present disclosure relate to a rechargeable lithium battery.

### 2. Description of the Related Art

A rechargeable lithium battery may be recharged and has three or more times as high energy density per unit weight as a lead storage battery, nickel cadmium battery, nickel hydrogen battery, nickel zinc battery and/or the like. The rechargeable lithium battery may be also charged at a high rate and thus, is commercially manufactured for a laptop, a cell phone, an electric tool, an electric bike, and/or the like, and research on increasing and/or improving upon energy densities has been actively conducted.

For example, as information technology (IT) devices become increasingly high-performance, high-capacity batteries may be required, wherein the high capacity may be realized by expanding a voltage region to increase energy density. However, there is a problem of oxidizing an electrolyte solution in the high voltage region and thus deteriorating performance of a positive electrode.

For example, cobalt-free lithium nickel manganese-based oxide is a positive active material including not cobalt (i.e., cobalt is excluded) but nickel, manganese, and/or the like as a main component in its composition, and accordingly, a positive electrode including the same may be economical and realize high energy density and thus this material has drawn attention as a possible next generation positive active material.

However, when the positive electrode including the cobalt-free lithium nickel manganese-based oxide is utilized in a high voltage environment, transition metals may be eluted due to structural collapse of the positive electrode, thereby causing a problem such as gas generation inside a cell, capacity reduction, and/or the like. This transition metal elution tends to be aggravated in a high temperature environment, wherein the eluted transition metals are precipitated on the surface of a negative electrode and may cause a side reaction and thereby increase battery resistance and deteriorate battery cycle-life and output characteristics.

Accordingly, when the positive electrode including the cobalt-free lithium nickel manganese-based oxide is utilized, an electrolyte solution applicable under high voltage and high temperature conditions is desired or required.

### SUMMARY

An aspect of one or more embodiments of the present disclosure is directed toward a rechargeable lithium battery exhibiting improved high-voltage characteristics and high-temperature characteristics by combining a positive electrode including cobalt-free lithium nickel manganese-based oxide with an electrolyte solution capable of effectively protecting the positive electrode including cobalt-free lithium nickel manganese-based oxide to reduce elution of transition metals under high voltage and high temperature conditions and thus to suppress or reduce structural collapse of the positive electrode.

Additional aspects will be set forth in part in the description which follows and, in part, will be apparent from the description, or may be learned by practice of the presented embodiments of the disclosure

An embodiment provides a rechargeable lithium battery including an electrolyte solution including a non-aqueous organic solvent, a lithium salt, and an additive; a positive electrode including a positive active material; and a negative electrode including a negative active material;

wherein the additive includes a compound represented by Chemical Formula 1, and

the positive active material includes a cobalt-free lithium nickel manganese-based oxide.

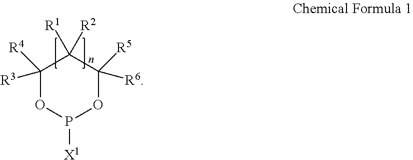

In Chemical Formula 1,

X¹ may be a fluoro group, a chloro group, a bromo group, or an iodo group,

R¹ to R⁶ may each independently be hydrogen, a cyano group, an isocyanate group, an isothiocyanate group, a halogen-substituted sulfonate group, a sulfonate group substituted with a C1 to C10 alkyl group, a sulfonate group substituted with a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and

n may be an integer of 0 or 1.

The Chemical Formula 1 may be represented by Chemical Formula 1-1.

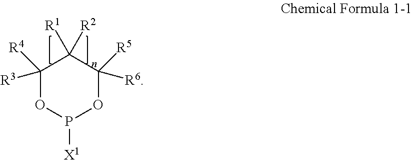

In Chemical Formula 1-1,

R¹ to R⁶ may each independently be hydrogen, a cyano group, an isocyanate group, an isothiocyanate group, a halogen-substituted sulfonate group, a sulfonate group substituted with a C1 to C10 alkyl group, a sulfonate group substituted with a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group or a substituted or unsubstituted C2 to C20 heteroaryl group, and

n may be an integer of 0 or 1.

The Chemical Formula 1-1 may be represented by Chemical Formula 1-1A or Chemical Formula 1-1B.

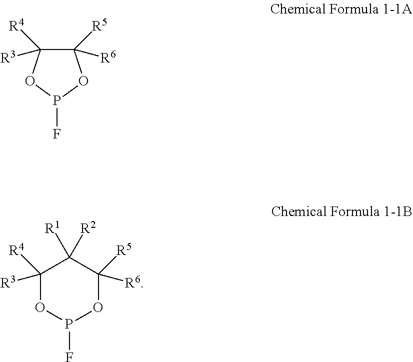

In Chemical Formula 1-1A and Chemical Formula 1-1B,

R¹ to R⁶ may each independently be hydrogen, a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

R³ and R⁴ of Chemical Formula 1-1A may each be hydrogen, and

R⁵ and R⁶ may each be hydrogen or at least one of R⁵ or R⁶ may be a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

The compound represented by Chemical Formula 1 may be selected from among compounds of Group 1

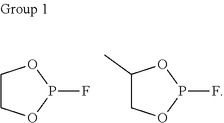

The compound represented by Chemical Formula 1 may be included in an amount of about 0.1 to 5.0 parts by weight based on 100 parts by weight of the electrolyte solution.

The electrolyte may further include at least one of other additives selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propensultone (PST), propanesultone (PS), lithium tetrafluoroborate (LiBF₄), lithium difluorophosphate (LiPO₂F₂), and 2-fluorobiphenyl (2-FBP).

The non-aqueous organic solvent may be composed of chain carbonate alone (e.g., consists of chain carbonate and/or is composed of only chain carbonate and not cyclic carbonate).

The chain carbonate may be represented by Chemical Formula 2.

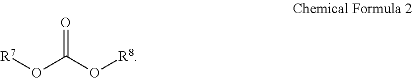

In Chemical Formula 2

R⁷ and R⁸ may each independently be a substituted or unsubstituted C1 to C20 alkyl group.

The non-aqueous organic solvent may include at least two types (kinds) of carbonates selected from among dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

The cobalt-free lithium nickel manganese-based oxide may include a lithium composite oxide represented by Chemical Formula 4.

LiₐNiₓMn_{y}M1_{z}M2_{w}O_{2-b}X_{b} Chemical Formula 4

In Chemical Formula 4,

0.9≤a<1.2, 0≤b<0.1, 0≤w<0.1, 0.6≤x<1.0, 0<y<0.4, 0<z<0.1, w+x+y+z=1,

M1 may be at least one element selected from among Al, Mg, Fe, Ti, Zr, Sr, V, W, Mo, Ce, Cr, and Nb, and

M2 may be at least one element selected from among B, Ba, Ca, and Si, and

X may be at least one element selected from among S, F, and P.

The Chemical Formula 4 may be represented by Chemical Formula 4-1.

LiₐNiₓ₁Mn_{y1}Al_{z1}M2_{w1}O_{2-b}X_{b} Chemical Formula 4-1

In Chemical Formula 4-1,

0.9≤a<1.2, 0≤b<0.1, 0≤w1<0.1, 0.6≤x1<1.0, 0<y1<0.4, 0<z1<0.1, w1+x1+y1+z1=1, M2 may be at least one element selected from among B, Ba, Ca, and Si, and X may be at least one element selected from among S, F, and P.

In Chemical Formula 4-1, x1 may be 0.6≤x1≤0.79, y1 may be 0.2≤y1≤0.39, and z1 may be 0.01≤z1<0.1.

The negative active material may include at least one of graphite or Si composite.

The Si composite may include a core including Si-based particles and/or amorphous carbon coating layer.

The Si-based particles may include at least one selected from among Si particles, a Si—C composite, SiOₓ (0<x≤2), and a Si alloy.

The rechargeable lithium battery may be operated at a high voltage of about 4.45 V or higher.

An embodiment may realize a rechargeable lithium battery exhibiting improved battery stability and cycle-life characteristics by combining a positive electrode including cobalt-free lithium nickel manganese-based oxide with an electrolyte solution capable of effectively protecting the positive electrode to secure phase transition safety of the positive electrode in a high temperature high voltage environment and to suppress or reduce decomposition of the electrolyte solution and a side reaction with electrodes and thus reduce gas generation and, concurrently (e.g., simultaneously), suppress or reduce an increase in internal battery resistance.

### BRIEF DESCRIPTION OF THE DRAWING

The accompanying drawing is included to provide a further understanding of the present disclosure, and is incorporated in and constitutes a part of this specification. The drawing illustrates example embodiments of the present disclosure and, together with the description, serves to explain principles of present disclosure. In the drawing:

The drawing is a cross-sectional view illustrating a rechargeable lithium battery according to an embodiment of the present disclosure.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, a rechargeable lithium battery according to an embodiment of the present disclosure will be described in more detail with reference to the accompanying drawing. However, these embodiments are merely examples and the present disclosure is not limited thereto.

Hereinafter, when a definition is not otherwise provided, “substituted” refers to replacement of hydrogen of a compound by a substituent selected from among a halogen atom (F, Br, Cl, or I), a hydroxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, and one or more combinations thereof.

A rechargeable lithium battery may be classified as a lithium ion battery, a lithium ion polymer battery, and/or a lithium polymer battery depending on the kinds of a separator and an electrolyte that are utilized. It also may be classified as cylindrical, prismatic, coin-type or kind, pouch-type or kind, and/or the like depending on shape. In some embodiments, it may be bulk type or kind and thin film type or kind depending on sizes. Structures and manufacturing methods for lithium ion batteries pertaining to this disclosure are generally utilized/generally available in the art.

Herein, as an example of a rechargeable lithium battery, a cylindrical rechargeable lithium battery is for example described in more detail. The drawing schematically shows the structure of a rechargeable lithium battery according to an embodiment. Referring to the drawing, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte impregnating the positive electrode 114, the negative electrode 112 and the separator 113, a battery case 120 housing the battery cell, and a sealing member 140 for sealing the battery case 120.

Hereinafter, a more detailed configuration of the rechargeable lithium battery 100 according to an embodiment is described in more detail.

A rechargeable lithium battery according to an embodiment includes a positive electrode, a negative electrode, and an electrolyte solution.

The electrolyte solution may include a non-aqueous organic solvent, a lithium salt, and an additive, and the additive may include a compound represented by Chemical Formula 1.

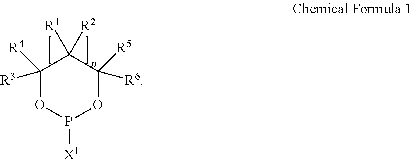

In Chemical Formula 1,

X¹ may be a fluoro group, a chloro group, a bromo group, or an iodo group,

R¹ to R⁶ may each independently be hydrogen, a cyano group, an isocyanate group, an isothiocyanate group, a halogen-substituted sulfonate group, a sulfonate group substituted with a C1 to C10 alkyl group, a sulfonate group substituted with a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group or a substituted or unsubstituted C2 to C20 heteroaryl group, and

n may be an integer of 0 or 1.

The compound represented by Chemical Formula 1 serves to prevent or reduce hydrolysis by stabilizing the LiPF₆ salt in the electrolyte solution.

For example, the compound represented by Chemical Formula 1 may be oxidized on the positive electrode surface and thus form phosphate functional groups, wherein these functional groups may work as (serve as) an anion receptor to stably form PF₆⁻ and increasingly separate ion pairs of Li⁺ and PF₆⁻, which may improve solubility of LiF inside the electrolyte solution and thus lower interface resistance.

In some embodiments, the compound represented by Chemical Formula 1 may be oxidized and decomposed on the positive electrode surface and thus form a cathode electrolyte interphase (CEI) film with high heat resistance, thereby suppressing decomposition of the electrolyte solution even at the high-temperature storage.

For example, the compound represented by Chemical Formula 1 has a lower oxidation potential than the solvent and thus forms a solid electrolyte interface (SEI) film on the negative electrode surface before the decomposition of the electrolyte solution, thereby suppressing a side reaction with the electrolyte solution and thus improving a swelling phenomenon.

As described above, the effects of suppressing the decomposition of the electrolyte solution and the side reaction with the electrolyte solution may be maximized or increased, when utilized with a positive electrode including cobalt-free lithium nickel manganese-based oxide, which will be described in more detail.

When the additive represented by Chemical Formula 1 and the positive electrode including cobalt-free lithium nickel manganese-based oxide are utilized as a combination, the transition metal elution under high voltage and high temperature conditions may be effectively reduced, thereby suppressing structural collapse of the positive electrode and improving high-voltage characteristics and high-temperature characteristics of a battery.

The Chemical Formula 1 may be represented by Chemical Formula 1-1.

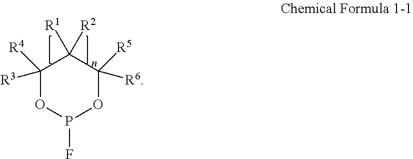

In Chemical Formula 1-1,

R¹ to R⁶ may each independently be hydrogen, a cyano group, an isocyanate group, an isothiocyanate group, a halogen-substituted sulfonate group, a sulfonate group substituted with a C1 to C10 alkyl group, a sulfonate group substituted with a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group or a substituted or unsubstituted C2 to C20 heteroaryl group, and

n may be an integer of 0 or 1.

The compound represented by Chemical Formula 1-1 has an electron-accepting fluorine substituent directly bonded to the central atom, phosphorus (P(III)), so that the stability of the CEI film on the surface of the positive electrode may be improved.

For example, Chemical Formula 1-1 may be represented by Chemical Formula 1-1A or Chemical Formula 1-1B.

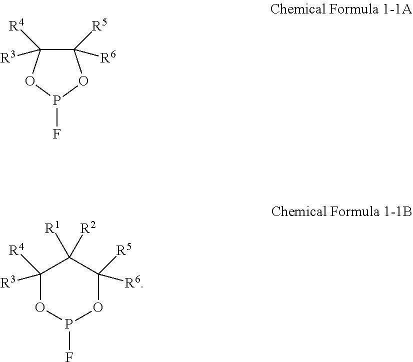

In Chemical Formula 1-1A and Chemical Formula 1-1B,

R¹ to R⁶ may each independently be hydrogen, a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, R³ and R⁴ of Chemical Formula 1-1A may each be hydrogen, and

R⁵ and R⁶ may each be hydrogen or at least one of R⁵ or R⁶ may be a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, the compound represented by Chemical Formula 1 may be selected from among the compounds of Group 1, for example, at least one selected from among 2-fluoro-1,3,2-dioxaphospholane and 2-fluoro-4-methyl-1,3,2-dioxaphospholane.

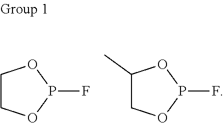

The compound represented by Chemical Formula 1 may be included in an amount of about 0.1 to 5.0 parts by weight, for example about 0.1 to 3.0 parts by weight, or about 0.1 to 2.0 parts by weight based on 100 parts by weight of the electrolyte solution.

When the amount of the compound represented by Chemical Formula 1 is within the above range, a rechargeable lithium battery having improved storage characteristics at a high temperature and cycle-life characteristics may be implemented (obtained).

In some embodiments, the electrolyte may further include other additives in addition to the aforementioned compound.

The electrolyte may further include at least one of the other additives selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propensultone (PST), propanesultone (PS), lithium tetrafluoroborate (LiBF₄), lithium difluorophosphate (LiPO₂F₂), and 2-fluorobiphenyl (2-FBP).

By further including the aforementioned other additives, the cycle-life may be further improved or gases generated from the positive electrode and the negative electrode may be effectively controlled or selected during high-temperature storage.

The other additives may be included in an amount of about 0.2 to 20 parts by weight, for example about 0.2 to 15 parts by weight, or for example, about 0.2 to 10 parts by weight, based on 100 parts by weight of the electrolyte solution for a rechargeable lithium battery.

When the other additives are in an amount as described above, the increase in film resistance may be minimized or reduced, thereby contributing to the improvement of battery performance.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may include methyl acetate, ethyl acetate, n-propyl acetate, t-butyl acetate, methylpropionate, ethylpropionate, propylpropionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In some embodiments, the ketone-based solvent may include cyclohexanone, and/or the like. The alcohol-based solvent may include ethanol, isopropyl alcohol, and/or the like and the aprotic solvent may include nitriles such as R—CN (wherein R is a hydrocarbon group having a C2 to C20 linear, branched, or cyclic structure and may include a double bond, an aromatic ring, or an ether bond), and/or the like, dioxolanes such as 1,3-dioxolane, and/or the like, sulfolanes, and/or the like.

The non-aqueous organic solvent may be utilized alone or in a mixture. When the non-aqueous organic solvent is utilized in a mixture, the mixture ratio may be controlled or selected in accordance with a desirable battery performance.

For example, the non-aqueous organic solvent may be composed of a chain carbonate alone. In this embodiment, excellent or suitable storage characteristics at a high temperature may be realized as a resistance increase rate is significantly reduced during high-temperature storage.

In the present disclosure, the meaning “composed of the chain carbonate” refers to a solvent that it is not mixed with the cyclic carbonate and/or the like and includes an organic solvent belonging to the category of the chain carbonate alone or in combination (with another chain carbonate solvent).

For example, the chain carbonate may be represented by Chemical Formula 2.

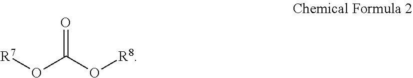

In Chemical Formula 2,

R⁷ and R⁸ may each independently be a substituted or unsubstituted C1 to C20 alkyl group.

For example, R⁷ and R⁸ in Chemical Formula 2 may each independently be a substituted or unsubstituted C1 to C10 alkyl group, and for example, R⁷ and R⁸ may each independently represent a substituted or unsubstituted C1 to C5 alkyl group.

In an embodiment, R⁷ and R⁸ in Chemical Formula 2 may each independently be a substituted or unsubstituted methyl group, a substituted or unsubstituted ethyl group, a substituted or unsubstituted n-propyl group, a substituted or unsubstituted n-butyl group, a substituted or unsubstituted n-pentyl group, a substituted or unsubstituted iso-butyl group, or a substituted or unsubstituted neo-pentyl group.

For example, the non-aqueous organic solvent according to an embodiment may be at least two types (kinds) of carbonates selected from among dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

The non-aqueous organic solvent according to an embodiment may be a mixed solvent of dimethyl carbonate (DMC) and ethylmethyl carbonate (EMC).

The non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound represented by Chemical Formula 3.

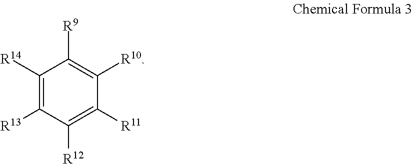

In Chemical Formula 3, R⁹ to R¹⁴ may each independently be the same or different and are selected from among hydrogen, a halogen, a C1 to C10 alkyl group, a C1 to C10 haloalkyl group, and one or more combinations thereof.

Examples of the aromatic hydrocarbon-based organic solvent may be selected from among benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and one or more combinations thereof.

The lithium salt dissolved in the non-aqueous organic solvent supplies lithium ions in a battery, enables a basic operation of a rechargeable lithium battery, and improves transportation of the lithium ions between positive and negative electrodes. Examples of the lithium salt may include at least one selected from among LiPF₆, LiBF₄, lithium difluoro(oxalato)borate (LiDFOB), LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiN(CₓF₂ₓ₊₁SO₂)(C_{y}F_{2y+1}SO₂), (wherein x and y are natural numbers, for example, an integer from 1 to 20), LiCl, LiI, and LiB(C₂O₄)₂ (lithium bis(oxalato) borate: LiBOB). The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

The positive electrode includes a positive electrode current collector and a positive active material layer formed on the positive electrode current collector, and the positive active material layer includes a positive active material.

The positive active material may include a cobalt-free lithium nickel manganese-based oxide.

In the present disclosure, the cobalt-free lithium nickel manganese-based oxide as a positive active material refers to a positive active material composed primarily of nickel, manganese, etc. without including cobalt (i.e., cobalt is excluded) in the composition of the positive active material.

For example, the cobalt-free lithium nickel manganese-based oxide may include at least one type or kind of lithium composite oxides represented by Chemical Formula 4.

LiₐNiₓMn_{y}M1_{z}M2_{w}O_{2-b}X_{b} Chemical Formula 4

In Chemical Formula 4,

0.9≤a<1.2, 0≤b<0.1, 0≤w<0.1, 0.6≤x<1.0, 0<y<0.4, 0<z<0.1, w+x+y+z=1,

M1 may be at least one element selected from among Al, Mg, Fe, Ti, Zr, Sr, V, W, Mo, Ce, Cr, and Nb, and

M2 may be at least one element selected from among B, Ba, Ca, and Si, and

X may be at least one element selected from among S, F, and P.

The lithium composite oxides may have a coating layer on the surface, or may be mixed with another lithium composite oxide having a coating layer. The coating layer may include at least one coating element compound selected from among an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or one or more mixtures thereof. The coating layer may be disposed in a method having no adverse influence on properties of a positive active material by utilizing these elements in the compound. For example, the method may include any suitable coating method (e.g., spray coating, dipping, etc.). These methods should be apparent to those of ordinary skill in the art upon reviewing the present disclosure.

For example, Chemical Formula 4 may be represented by Chemical Formula 4-1.

LiₐNiₓ₁Mn_{y1}Al_{z1}M2_{w1}O_{2-b}X_{b} Chemical Formula 4-1

In Chemical Formula 4-1,

0.9≤a<1.2, 0≤b<0.1, 0≤w1<0.1, 0.6≤x1<1.0, 0<y1<0.4, 0<z1<0.1, w1+x1+y1+z1=1, M2 may be at least one element selected from among B, Ba, Ca, and Si, and X is at least one element selected from among S, F, and P.

In an embodiment, in Chemical Formula 4-1, 0.6≤x1≤0.9, 0.1≤y1≤0.4, and 0≤z1≤0.1, or 0.6≤x1≤0.8, 0.2≤y1≤0.4, and 0≤z1≤0.1.

For example, in Chemical Formula 4-1, x1 may be 0.6≤x1≤0.79, y1 may be 0.2≤y1≤0.39, and z1 may be 0.01≤z1<0.1.

The positive active material may be included in an amount of about 90 wt % to about 98 wt % based on the total weight of the positive active material layer.

In an embodiment, the positive active material layer may include a binder. In this embodiment, an amount of the binder may be about 1 wt % to about 5 wt % based on the total weight of the positive active material layer.

The binder improves binding properties of positive active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but is not limited thereto.

Al may be utilized as the positive electrode current collector, but is not limited thereto.

The negative electrode includes a negative electrode current collector and a negative electrode active material layer including a negative active material formed on the negative current collector.

The negative active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include a carbon material. The carbon material may be any generally-utilized/generally available carbon-based negative active material in a rechargeable lithium battery. Examples thereof may be crystalline carbon, amorphous carbon, or a mixture thereof. The crystalline carbon may be substantially non-shaped, or sheet, flake, spherical, or fiber shaped natural graphite or artificial graphite. The amorphous carbon may be a soft carbon, a hard carbon, a mesophase pitch carbonization product, calcined coke, and/or the like.

The lithium metal alloy may include an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, Si—C composite, SiOₓ (0<x<2), a Si-Q alloy wherein Q is an element selected from among an alkali metal, an alkaline-earth metal, a Group 13 element, a Group 14 element excluding Si, a Group 15 element, a Group 16 element, a transition metal, a rare earth element, and one or more combinations thereof, Sn, SnO₂, a Sn—R alloy (wherein R is an element selected from among an alkali metal, an alkaline-earth metal, a Group 13 element, a Group 14 element excluding Sn, a Group 15 element, a Group 16 element, a transition metal, a rare earth element, and one or more combinations thereof, and/or the like. At least one of the foregoing materials may be mixed with SiO₂. The elements Q and R may be selected from among Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn (excluded for R), In, TI, Ge, P, As, Sb, Bi, S, Se, Te, Po, and one or more combinations thereof.

The transition metal oxide may be vanadium oxide, lithium vanadium oxide, or lithium titanium oxide.

In an embodiment, the negative active material may include at least one of graphite or a Si composite.

The Si composite may include a core including Si-based particles and/or amorphous carbon coating layer.

The Si-based particles may include at least one selected from among Si particles, a Si—C composite, SiOₓ (0<x≤2), and a Si alloy.

The central portion of the core including Si-based particles may include voids, and a radius of the central portion may correspond to about 30% to about 50% of the radius of the Si composite, an average particle diameter of the Si composite may be about 5 μm to 20 μm, and an average particle diameter of the Si-based particles may be about 10 nm to about 200 nm.

In the present disclosure, the average particle diameter may be a particle size (D50) at 50% by volume in a cumulative size-distribution curve. For example, the average particle diameter may be, for example, a median diameter (D50) measured utilizing a laser diffraction particle diameter distribution meter.

When the Si-based particles have an average particle diameter within the foregoing range, volume expansion during the charge and discharge may be suppressed or reduced, and interruption of a conductive path due to particle crushing during the charge and discharge may be prevented or reduced.

The core including Si-based particles may further include amorphous carbon, in this embodiment the central portion does not include amorphous carbon, and the amorphous carbon may be present only on the surface portion of the Si composite.

Herein, the surface portion refers to a region from the outermost surface of the center portion to the outermost surface of the Si composite.

In some embodiments, the Si particles are substantially uniformly included in the negative active material as a whole, for example, the Si particles may be present in a substantially uniform concentration in the center portion and the surface portion.

The amorphous carbon may be soft carbon, hard carbon, a mesophase pitch carbonized product, calcined coke, or one or more combinations thereof.

The amorphous carbon precursor (e.g., for the amorphous carbon included in the Si—C composite) may include a coal-based pitch, mesophase pitch, petroleum-based pitch, coal-based oil, petroleum-based heavy oil, and/or a polymer resin such as a phenol resin, a furan resin, and/or a polyimide resin.

For example, the Si—C composite may include a core including Si particles and/or crystalline carbon.

The Si particles may be included in a weight of about 1 to 60 wt %, for example about 3 to 60 wt % of the total weight of the Si—C composite.

The crystalline carbon may be, for example graphite, for example natural graphite, artificial graphite, or a mixture thereof.

The average particle diameter of the crystalline carbon may be about 5 μm to 30 μm.

When the negative active material includes the Si composite and the graphite together, the Si composite and the graphite may be included as a mixture, wherein the Si composite and the graphite may be included in a weight ratio of about 1:99 to about 50:0. For example, the Si composite and the graphite may be included in a weight ratio of about 3:97 to about 20:80 or about 5:95 to about 20:80.

In the negative active material layer, the negative active material may be included in an amount of about 95 wt % to about 99 wt % based on a total weight of the negative active material layer.

In an embodiment of the present disclosure, the negative active material layer includes a binder, and optionally a conductive material. In the negative active material layer, a content (e.g., amount) of the binder may be about 1 wt % to about 5 wt % based on a total weight of the negative active material layer. When the negative active material layer includes a conductive material, the negative active material layer includes about 90 wt % to about 98 wt % of the negative active material, about 1 wt % to about 5 wt % of the binder, and about 1 wt % to about 5 wt % of the conductive material.

The binder improves binding properties of negative active material particles with one another and with a negative electrode current collector. The binder includes a non-water-soluble binder, a water-soluble binder, or a combination thereof.

The non-water-soluble binder may be selected from among polyvinylchloride, carboxylated polyvinylchloride, polyvinylfluoride, polyurethane, polytetrafluoroethylene, polyvinylidene fluoride, polyethylene, polypropylene, polyamideimide, polyimide, one or more combinations thereof.

The water-soluble binder may be a rubber-based binder or a polymer resin binder. The rubber-based binder may be selected from among a styrene-butadiene rubber, an acrylated styrene-butadiene rubber (SBR), an acrylonitrile-butadiene rubber, an acrylic rubber, a butyl rubber, a fluorine rubber, and one or more combinations thereof. The polymer resin binder may be selected from among polytetrafluoroethylene, ethylene-propylene copolymer, polyethyleneoxide, polyvinylpyrrolidone, polyepichlorohydrine, polyphosphazene, polyacrylonitrile, polystyrene, an ethylene-propylene-diene copolymer, polyvinylpyridine, chlorosulfonated polyethylene, latex, a polyester resin, an acrylic resin, a phenolic resin, an epoxy resin, polyvinyl alcohol, and one or more combinations thereof.

When the water-soluble binder is utilized as a negative electrode binder, a cellulose-based compound as a thickener may be further utilized to provide viscosity. The cellulose-based compound includes one or more selected from among carboxymethyl cellulose, hydroxypropylmethyl cellulose, methyl cellulose, and alkali metal salts thereof. The alkali metals may be Na, K, or Li. Such a thickener may be included in an amount of about 0.1 to about 3 parts by weight based on 100 parts by weight of the negative active material.

The conductive material is included to provide electrode conductivity. Any suitable electrically conductive material may be utilized as a conductive material unless it causes a chemical change (an adverse chemical change). Examples of the conductive material include a carbon-based material such as natural graphite, artificial graphite, carbon black, acetylene black, ketjen black, a carbon fiber, and/or the like; a metal-based material of a metal powder or a metal fiber including copper, nickel, aluminum silver, and/or the like; a conductive polymer such as a polyphenylene derivative; or one or more mixtures thereof.

The negative electrode current collector may include one or more materials selected from among a copper foil, a nickel foil, a stainless steel foil, a titanium foil, a nickel foam, a copper foam, a polymer substrate coated with a conductive metal, and one or more combinations thereof.

The rechargeable lithium battery may further include a separator between the negative electrode and the positive electrode, depending on a type or kind of the rechargeable lithium battery. Examples of a suitable separator material include polyethylene separator, polypropylene separator, polyvinylidene fluoride separator, or multi-layers thereof such as a polyethylene/polypropylene double-layered separator, a polyethylene/polypropylene/polyethylene triple-layered separator, and/or a polypropylene/polyethylene/polypropylene triple-layered separator.

The rechargeable lithium battery may be operated even at a voltage of about 4.45 V or higher. For example, a range of about 4.45 V to about 4.55 V based on the positive electrode is more desirable than voltages less than 4.45 V.

Hereinafter, examples of the present disclosure and comparative examples are described in more detail. These examples, however, are not in any sense to be interpreted as limiting the scope of the present disclosure.

### Manufacture of Rechargeable Lithium Battery Cell

### EXAMPLE 1

LiNi_{0.75}Mn_{0.23}Al_{0.02}O₂ as a positive active material, polyvinylidene fluoride as a binder, and acetylene black as a conductive material were mixed in a weight ratio of 96:3:1 and then, dispersed in N-methyl pyrrolidone, in preparing a positive active material slurry.

The positive active material slurry was coated on a 15 μm -thick Al foil, dried at 100° C., and pressed, manufacturing a positive electrode.

A negative active material slurry was prepared by utilizing a mixture of artificial graphite and Si composite in a weight ratio of 93:7 as a negative active material and then, mixing the negative active material, a styrene-butadiene rubber binder, and carboxylmethyl cellulose in a weight ratio of 98:1:1 and dispersing the obtained mixture in distilled water.

As for the Si composite, a core including artificial graphite and silicon particles was coated with coal-based pitch on the surface.

The negative active material slurry was coated on a 10 μm -thick Cu foil, dried at 100° C., and pressed, manufacturing a negative electrode.

The manufactured positive and negative electrodes were assembled with a 10 μm -thick polyethylene separator to manufacture an electrode assembly, and an electrolyte solution was injected thereinto, manufacturing a rechargeable lithium battery cell.

The electrolyte solution had a following composition.

### Composition of Electrolyte Solution

Lithium Salt: LiPF₆ 1.5 M

Non-aqueous Organic Solvent: ethylene carbonate (EC): ethylmethyl carbonate (EMC): dimethyl carbonate (DMC) (EC:EMC:DMC=a volume ratio of 20:10:70)

Additive: 0.25 parts by weight of 2-fluoro-4-methyl-1,3,2-dioxaphospholane, 10 parts by weight of fluoroethylene carbonate (FEC), and 0.5 parts by weight of succinonitrile (SN)

(However, in the above composition of the electrolyte solution, “parts by weight” refers to the relative weight of the additive based on 100 parts by weight of the total electrolyte solution excluding additives (lithium salt+non-aqueous organic solvent.)

### EXAMPLES 2 AND 3

Rechargeable lithium battery cells were manufactured in substantially the same manner as in Example 1 except that the content (e.g., amount) of the additive (i.e., 2-fluoro-4-methyl-1,3,2-dioxaphospholane) was changed respectively into 0.5 parts by weight and 1.0 parts by weight.

### EXAMPLES 4 TO 6

Rechargeable lithium battery cells were manufactured in substantially the same manner as in Examples 1 to 3 except that the electrolyte solution was prepared by changing the volume ratio of ethylmethyl carbonate (EMC):dimethyl carbonate (DMC) into 60:40.

### Comparative Example 1

A rechargeable lithium battery cell was manufactured in substantially the same manner as in Example 1 except that an electrolyte solution including no 2-fluoro-4-methyl-1,3,2-dioxaphospholane was utilized (2-fluoro-4-methyl-1,3,2-dioxaphospholane was excluded).

### Comparative Example 2

A rechargeable lithium battery cell was manufactured in substantially the same manner as in Example 1 except that the positive active material was LiCoO₂.

### Comparative Examples 3 to 5

Rechargeable lithium battery cells were manufactured in substantially the same manner as in Examples 4 to 6 except that the positive active material was LiCoO₂, and the electrolyte solution was prepared by changing the content (e.g., amount) of the additive (i.e., 2-fluoro-4-methyl-1,3,2-dioxaphospholane) respectively into 0.25 parts by weight, 0.5 parts by weight, and 1.0 parts by weight.

### Evaluation 1: Evaluation of Storage Characteristics at High Temperature

The rechargeable lithium battery cells according to Examples 1 to 6 and Comparative Examples 1 to 5 were measured with respect to initial DC resistance (direct current internal resistance (DCIR)) as οV/ΔI (voltage change/current change), then, DC resistance thereof was measured again by setting a maximum energy state inside the rechargeable lithium battery cells to a fully charged state (state of charge (SOC) 100%) and then, storing them at a high temperature of 60° C. for 30 days to calculate a DCIR increase rate (%) according to Equation 1, and the results are shown in Tables 1 and 2.

DCIR increase rate={DCIR after 30 days/initial DCIR}×100% Equation 1

### Evaluation 2: Evaluation of High Temperature Cycle-Life Characteristics

The rechargeable lithium battery cells according to Examples 1 to 6 and Comparative Example 1 were once charged and discharged at 0.2 C and then, measured with respect to charge and discharge capacity (before being stored at a high temperature).

In some embodiments, the rechargeable lithium battery cells according to Examples 1 to 6 and Comparative Example 1 were stored at 60° C. for 30 days after charged at SOC 100% (a state of being charged to 100% of charge capacity based on 100% of total battery charge capacity) and then, discharged to 3.0 V under a constant current condition of 0.2 C and measured with respect to initial discharge capacity.

Subsequently, discharge capacity thereof was measured again by recharging the cells to 4.4 V under the constant current condition of 0.2 C and at a termination current of 0.05 C under the constant voltage condition and discharging them to 3.0 V at 0.2 C. A ratio of the discharge capacity to the initial discharge capacity is shown as a capacity retention rate (%, retention) in Table 1.

### Evaluation 3: Measurement of Gas Generation After High-Temperature Storage

The rechargeable lithium battery cells according to Examples 4 to 6 and Comparative Example 1 were allowed to stand at 60° C. for 7 days, and then, refinery gas analysis (RGA) was utilized to measure gas generation amounts (mL) at the 1^{st} day and the 7^{th} day, and the results are shown in Table 3.

TABLE 1

| | | DCIR after | DCIR | Capacity |
|---|---|---|---|---|
| | Initial | high-temperature | Increase rate | retention |
| | DCIR | storage | (60° C., 30 | rate |
| | (mOhm) | (mOhm) | days) (%) | (%) |
| Comparative | 42.29 | 51.59 | 122 | 85.3 |
| Example 1 | | | | |
| Example 1 | 42.35 | 49.97 | 118 | 86.5 |
| Example 2 | 42.59 | 49.40 | 116 | 89.2 |
| Example 3 | 42.69 | 50.80 | 119 | 88.9 |
| Example 4 | 42.28 | 45.66 | 108 | 88.2 |
| Example 5 | 42.35 | 44.89 | 106 | 90.6 |
| Example 6 | 42.45 | 46.27 | 109 | 90.2 |

Referring to Table 1, in the compositions according to the present disclosure in which the additive was combined with a Co-free positive active material (Co was excluded), the DC-IR increase rate at the high temperature storage was reduced, which lead to the storage characteristics at a high temperature being improved, and the retention capacity was increased, which lead to high temperature cycle-life characteristics also being improved.

For example, the aforementioned storage characteristics at a high temperature was further maximized or increased in a non-aqueous organic solvent composed of chain carbonate.

TABLE 2

| | | | DCIR | DCIR | |
|---|---|---|---|---|---|
| | | | after high | Increase | |
| | | Initial | temperature | rate | Relative |
| | | DCIR | storage | (60° C., 30 | value |
| Positive active material | | (mOhm) | (mOhm) | days) (%) | (%) |
| LiNi_{0.75}Mn_{0.23}Al_{0.02}O₂ | Comparative | 42.29 | 51.59 | 122 | 100 |
| | Example 1 | | | | |
| | Example 4 | 42.28 | 45.66 | 108 | 88.5 |
| | Example 5 | 42.35 | 44.89 | 106 | 86.9 |
| | Example 6 | 42.45 | 46.27 | 109 | 89.3 |
| LiCoO₂ | Comparative | 41.25 | 52.38 | 126 | 100 |
| | Example 2 | | | | |
| | Comparative | 42.01 | 53.21 | 126 | 100 |
| | Example 3 | | | | |
| | Comparative | 42.05 | 52.49 | 124 | 98.4 |
| | Example 4 | | | | |
| | Comparative | 42.07 | 52.36 | 124 | 98.4 |
| | Example 5 | | | | |

Referring to Table 2, the rechargeable lithium battery cells utilizing the compositions in which the additive was combined with the Co-free positive active material exhibited a significantly decreased DC-IR increase rate at the high temperature storage and thus significantly improved storage characteristics at a high temperature, compared with the rechargeable lithium battery cell utilizing the composition in which a LiCoO₂ positive active material was combined.

TABLE 3

| | Gas generation after storage at | | |
|---|---|---|---|
| | high temperature (60° C.) | | |
| | 1 day | 7 days | Increase rate |
| | (mL) | (mL) | (%) |
| Comparative | 0.031 | 0.076 | 145 |
| Example 1 | | | |
| Example 4 | 0.021 | 0.040 | 90 |
| Example 5 | 0.022 | 0.038 | 72 |
| Example 6 | 0.022 | 0.036 | 64 |

Referring to Table 3, in the rechargeable lithium battery cells utilizing the compositions in which the Co-free positive active material was combined, the gas generation amounts after the storage at a high temperature were significantly reduced.

The use of “may” when describing embodiments of the present disclosure refers to “one or more embodiments of the present disclosure.”

As used herein, the singular forms “a”, “an” and “the” are intended to include the plural forms as well, unless the context clearly indicates otherwise.

In the present disclosure, when particles are spherical, “diameter” indicates an average particle diameter, and when the particles are non-spherical, the “diameter” indicates a major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

As used herein, the term “substantially”, “about” and similar terms are used as terms of approximation and not as terms of degree, and are intended to account for the inherent deviations in measured or calculated values that would be recognized by those of ordinary skill in the art. “About”, “substantially”, or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this disclosure is intended to include all higher numerical limitations subsumed therein. Accordingly, Applicant reserves the right to amend this disclosure, including the claims, to expressly recite any sub-range subsumed within the ranges expressly recited herein.

The portable information device, the electric vehicle, the rechargeable lithium battery including its battery management system (BMS) or device, or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components may be implemented on a flexible printed circuit film, a tape carrier package (TCP), a printed circuit board (PCB), or formed on one substrate. Further, the various components may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

### REFERENCE NUMERALS

100: rechargeable lithium battery

112: negative electrode

113: separator

114: positive electrode

120: battery case

140: sealing member

What is claimed is:

1. A rechargeable lithium battery, comprising
an electrolyte solution comprising a non-aqueous organic solvent, a lithium salt, and an additive;
a positive electrode comprising a positive active material; and
a negative electrode comprising a negative active material,
wherein the additive comprises a compound represented by Chemical Formula 1, and
the positive active material comprises a cobalt-free lithium nickel manganese-based oxide: 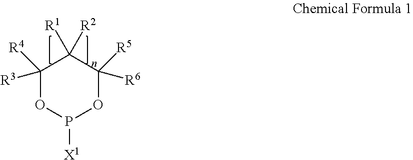
wherein, in Chemical Formula 1,
X¹ is a fluoro group, a chloro group, a bromo group, or an iodo group,
R¹ to R⁶ are each independently hydrogen, a cyano group, an isocyanate group, an isothiocyanate group, a halogen-substituted sulfonate group, a sulfonate group substituted with a C1 to C10 alkyl group, a sulfonate group substituted with a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group or a substituted or unsubstituted C2 to C20 heteroaryl group, and
n is an integer of 0 or 1.

2. The rechargeable lithium battery of claim 1, wherein Chemical Formula 1 is represented by Chemical Formula 1-1: 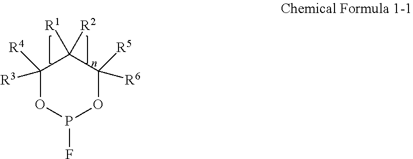
wherein, in Chemical Formula 1-1,
R¹ to R⁶ are each independently hydrogen, a cyano group, an isocyanate group, an isothiocyanate group, a halogen-substituted sulfonate group, a sulfonate group substituted with a C1 to C10 alkyl group, a sulfonate group substituted with a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group or a substituted or unsubstituted C2 to C20 heteroaryl group, and
n is an integer of 0 or 1.

3. The rechargeable lithium battery of claim 2, wherein
Chemical Formula 1-1 is represented by Chemical Formula 1-1A or Chemical Formula 1-1B: 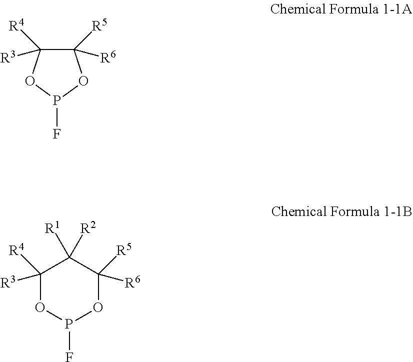
wherein, in Chemical Formula 1-1A and Chemical Formula 1-1B,
R¹ to R⁶ are each independently hydrogen, a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

4. The rechargeable lithium battery of claim 3, wherein
R³ and R⁴ of Chemical Formula 1-1A are each hydrogen, and
R⁵ and R⁶ are each hydrogen or at least one of R⁵ or R⁶ is a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

5. The rechargeable lithium battery of claim 1, wherein
the compound represented by Chemical Formula 1 is at least one selected from among compounds of Group 1:

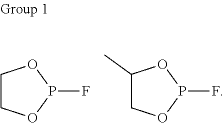

6. The rechargeable lithium battery of claim 1, wherein
the compound represented by Chemical Formula 1 is included in an amount of about 0.1 to 5.0 parts by weight based on 100 parts by weight of the electrolyte solution.

7. The rechargeable lithium battery of claim 1, wherein
the additive further comprises at least one of other additives selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propensultone (PST), propanesultone (PS), lithium tetrafluoroborate (LiBF₄), lithium difluorophosphate (LiPO₂F₂), and 2-fluorobiphenyl (2-FBP).

8. The rechargeable lithium battery of claim 1, wherein
the non-aqueous organic solvent is composed of chain carbonate alone.

9. The rechargeable lithium battery of claim 8, wherein
the chain carbonate is represented by Chemical Formula 2: 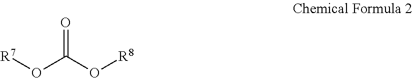
wherein, in Chemical Formula 2,
R⁷ and R⁸ are each independently a substituted or unsubstituted C1 to C20 alkyl group.

10. The rechargeable lithium battery of claim 9, wherein
the non-aqueous organic solvent comprises at least two carbonates selected from among dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

11. The rechargeable lithium battery of claim 1, wherein
the cobalt-free lithium nickel manganese-based oxide comprises a lithium composite oxide represented by Chemical Formula 4:
LiₐNiₓMn_{y}M1_{z}M2_{w}O_{2-b}X_{b} Chemical Formula 4
wherein, in Chemical Formula 4,
0.9≤a<1.2, 0≤b<0.1, 0≤w<0.1, 0.6≤x<1.0, 0<y<0.4, 0<z<0.1, w+x+y+z=1,
M1 is at least one element selected from among Al, Mg, Fe, Ti, Zr, Cr, Sr, V, W, Mo, Ce, Cr, and Nb,
M2 is at least one element selected from among B, Ba, Ca, and Si, and
X is at least one element selected from among S, F, and P.

12. The rechargeable lithium battery of claim 11, wherein
Chemical Formula 4 is represented by Chemical Formula 4-1:
LiₐNiₓ₁Mn_{y1}Al_{z1}M2_{w1}O_{2-b}X_{b} Chemical Formula 4-1
wherein, in Chemical Formula 4-1,
0.9≤a<1.2, 0≤b<0.1, 0≤w1<0.1, 0.6≤x1<1.0, 0<y1<0.4, 0<z1<0.1, w1+x1+y1+z1=1, M2 is at least one element selected from among B, Ba, Ca, and Si, X is at least one element selected from among S, F, and P.

13. The rechargeable lithium battery of claim 12, wherein
in Chemical Formula 4-1, x1 is 0.6≤x1≤0.79, y1 is 0.2≤y1 0.39, and z1 is 0.01≤z1<0.1.

14. The rechargeable lithium battery of claim 1, wherein
the negative active material comprises at least one of graphite or Si composite.

15. The rechargeable lithium battery of claim 14, wherein
the Si composite comprises a core comprising Si-based particles and amorphous carbon coating layer.

16. The rechargeable lithium battery of claim 15, wherein
the Si-based particles comprise at least one selected from among Si particles, a Si—C composite, SiOₓ, 0<x≤2, and a Si alloy. higher.

17. The rechargeable lithium battery of claim 1, wherein
the rechargeable lithium battery is operated at a high voltage of about 4.45 V or higher.

18. A portable information device comprising the rechargeable lithium battery of claim 1.

19. An electric vehicle comprising the rechargeable lithium battery of claim 1.
